(19) United States
(12) Patent Application Publication
(10) Pub. No.: US 2006/0133245 A1
(43) Pub. Date: Jun. 22, 2006

(54) Optical disk apparatus

(75) Inventor: Toshiki Saeki, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/312,916

(22) Filed: Dec. 21, 2005

(30) Foreign Application Priority Data
Dec. 21, 2004 (JP) P.2004-370137

(51) Int. Cl. G11B 5/09

(52) U.S. Cl. 369/53.1; 369/47.1

(57) ABSTRACT

An optical disk apparatus includes: a recording quality determination unit for, when a recording/reading unit has recorded data on an optical disk, reading the data recorded this time from the optical disk, and determining whether the recording quality of the data is at a proper level or not, wherein when the recording quality of the data has been determined to be not at a proper level, and the type of the optical disk on which the data has been recorded this time is a rewritable type, the recording/reading unit executes an erasing processing of erasing the recorded data on the recording area in which the data has been recorded this time in the optical disk, and executes a rerecording processing of recording the same data again on the recording area in which the data has been erased with this erasing processing.

### BACKGROUND OF THE INVENTION

1. Field of the Invention

This invention relates to an optical disk apparatus capable of performing recording of data and reading of the recorded data with respect to an optical disk such as a CD or a DVD.

2. Description of the Related Art

Conventionally, an optical disk apparatus capable of performing recording of data and reading of the recorded data with respect to an optical disk such as a CD or a DVD has been put into actual use, and commonly used. The optical disks on which data can be recorded include a write-once type one such as a CD-R or a DVD-R in which rewriting or erasing of the recorded data cannot be performed (recording of data can be performed only once on the same recording area), and a rewritable type one such as a CD-RW or a DVD-RAM on which rewriting or erasing of the recorded data can be performed (recording of data can be performed many times on the same recording area). For the general optical disk apparatuses, when data is recorded on a rewritable type optical disk, data is recorded by the direct overwrite method (which is hereinafter simply referred to as the overwrite method). The overwrite method is, as is known, a method for simultaneously performing erasure of the data already recorded on the recording area on which data is to be recorded this time and recording of data (data to be recorded this time). The optical disk apparatuses which record data by the overwrite method are shown in, for example, JP-A-2001-155342 and JP-A-2003-272148.

Whereas, JP-A-2001-155342 proposes the following. The rewritable type optical disk has a characteristic that recording of data with a recording quality at a proper level becomes impossible to perform when the number of overwriting operations falls within a certain range, for example, the number of overwriting operations is 2 to 5. Based on this, when data has been recorded on a rewritable type optical disk, and the recording quality of the recorded data is not at a proper level, a processing of rerecording the same data on the same recording area is repeated until the data can be recorded at a proper level.

Whereas, JP-A-2003-272148 proposes the following. With recording of data by the overwrite method, when overwriting is performed with a lower recording power than the recording power when the data to be erased (the data to be overwritten) has been recorded, the recording quality is reduced (the error ratio increases). Based on this idea, when data has been recorded on a rewritable type optical disk, and the recording quality of the recorded data is not at a proper level, a processing of recording the same data is performed on the same recording area with an increased recording power

However, in JP-A-2001-155342, when it has not been possible to perform recording of data with a recording quality at a proper level on a rewritable type optical disk, data is recorded with the same recording power. Therefore, in rerecording of data, overwriting is performed with the same recording power as the recording power for recording of the data to be erased. Thus, as described in JP-A-2003-272148, there is a high possibility that the recording quality is reduced. As a result, the processing related to rerecording of data is repeated many times, unfavorably resulting in an increase in length of the processing time required for recording of data.

Whereas, with the constitution in which rerecording of data is performed by increasing the recording power of the laser light to be applied onto an optical disk, described in JP-A-2003-272148, the recording power for rerecording of data deviates from the optimum recording power. For this reason, also in this rerecording, there is a high possibility that it is not possible to perform recording with a recording quality at a proper level, unfavorably resulting in an increase in length of the processing time required for recording of data.

### SUMMARY OF THE INVENTION

It is an object of this invention to provide an optical disk apparatus whereby the increase in length of time required for a processing of recording data on a write-once type optical disk with an overwrite method is suppressed.

An optical disk apparatus of this invention has the following constitution for solving the problems.

According to a first aspect of the invention, there is provided an optical disk apparatus including: a recording/reading unit for performing recording and reading of data with respect to an optical disk set in a main body; and a recording quality determination unit for when the recording/reading unit has recorded data on the optical disk set in the main body, reading the data recorded this time from the optical disk, and determining whether the recording quality of the data recorded this time is at a proper level or not, wherein when the recording quality of the data recorded this time has been determined to be not at a proper level by the recording quality determination unit, and when the type of the optical disk on which the data has been recorded this time is a rewritable type, the recording/reading unit executes an erasing processing of erasing the recorded data on the recording area in which the data has been recorded this time in the optical disk, and executes a rerecording processing of recording the same data again on the recording area in which the data has been erased with this erasing processing.

With this constitution, when the recording/reading unit has recorded data on the optical disk, whether the recording quality of the data recorded this time is at a proper level or not determined by the recording quality determination unit. The wording “the recording quality is at a proper level” means that it is possible to property reproduce the recorded data. In other words, it means that there is a high possibility that the recorded data cannot be reproduced when the recording quality is not at a proper level. Optical disks such as a CD and a DVD include, as is known, a write-once type one on which rewriting or erasing of the recorded data cannot be performed, and a rewritable type on which rewriting or erasing of the recorded data can be performed many times. Recording of data on a rewritable type optical disk is performed by a direct overwrite method in which erasing of the already recorded data and writing of data to be recorded this time are performed at the same time (which is hereinafter simply referred to as an overwrite method). In the case where the recording quality determination unit has determined that the recording quality of the recorded data is not at proper level, when the optical disk on which the data has been recorded this time is a rewritable type optical disk, the recording/reading unit performs an erasing processing of erasing the data on the recording area on which the data has been recorded this time, and then, performs recording of data again on the recording area in which the data has been erased, i.e., the recording area in which data has not been able to be recorded at a proper level this time.

Thus, when data has been recorded on a rewritable type optical disk, and the recording quality of the recorded data is not at a proper level, erasure of erasing the recorded data is performed on the recording area in which the data has been recorded this time, and then, rerecording of data is performed. Therefore, in rerecording of data, the number of overwriting operations on the recording area increases by 2. Further, the data has been erased, and hence, it is possible to perform rerecording of data with the optimum recording power. This can prevent the occurrence of the situation in which the recording quality of the rerecorded data is not at a proper level. As a result, it is possible to suppress the increase in length of time required for the processing of recording data on a write-once type optical disk with the overwrite method.

According to a second aspect of the invention, every time the recording/reading unit records a predetermined amount of data on the rewritable type optical disk, the recording quality determination unit determines whether the recording quality is at a proper level or not with respect to a predetermined amount of the data recorded immediately before.

With this constitution, every time the recording/reading unit records a predetermined amount of data on the optical disk, whether the recording quality is at a proper level or not is determined with respect to a predetermined amount of the data. Then, rerecording of data is performed on the recording area not at a proper level. This can prevent rerecording of data from being performed on the recording area in which the recording quality is at a proper level. Therefore, it is possible to further suppress the increase in length of time required for the processing of recording of data on a write-once type optical disk with the overwrite method.

According to a third aspect of the invention, when the recording quality of the data recorded this time has been determined to be not at a proper level by the recording quality determination unit, and when the type of the optical disk on which the data has been recorded this time is not a rewritable type, the recording/reading unit executes a rerecording processing of recording the same data again on another recording area than the recording area in which the data has been recorded this time in the optical disk.

With this constitution, when the optical disk on which data has been recorded is a write-once type optical disk, the data which has not been able to be recorded at a proper recording quality is recorded on another recording area.

In accordance with this invention, when data has been recorded on a write-once type optical disk with an overwrite method, the recording quality of the recorded data is not at a proper level, and rerecording of data is performed, it is possible to prevent the occurrence of the situation in which the recording quality of the rerecorded data is not at a proper level. As a result, it is possible to suppress the increase in length of time required for the processing of recording data on a write-once type optical disk with an overwrite method.

### BRIEF DESCRIPTION OF THE DRAWINGS

These and other objects and advantages of this invention will become more fully apparent from the following detailed description taken with the accompanying drawings in which:

FIG. 1 is a diagram showing a constitution of an essential part of an optical disk apparatus which is an embodiment of this invention;

FIG. 2 is a flow chart showing the reproduction operation of the optical disk apparatus of this embodiment; and

FIG. 3 is a flow chart showing the recording operation in the optical disk apparatus of this embodiment.

### DETAILED DESCRIPTION OF THE PREFERRED EMBODIMENTS

Below, an optical disk apparatus which is an embodiment of this invention will be described.

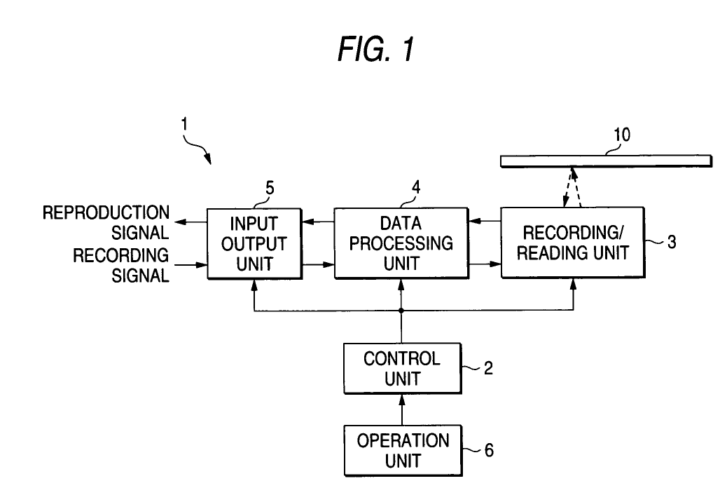

FIG. 1 is a diagram showing a constitution of an essential part of the optical disk apparatus which is an embodiment of this invention. The optical disk apparatus 1 of this embodiment includes a control unit 2 for controlling the operation of the main body, a recording/reading unit 3 for performing recording, erasing, and reading of data with respect to an optical disk 10 such as a CD or a DVD set in the main body, a data processing unit 4 for processing the data to be recorded on the optical disk 10 or the data read from the optical disk 10, an input output unit 5 for controlling input to and output from an external device, and an operation unit 6 for performing an input operation on the apparatus main body. The recording/reading unit 3 has a pick-up head (not shown). The pick-up head is provided with a laser diode (LD) for irradiating the optical disk 10 with a laser light, a plurality of photodetectors (PD) for detecting the reflected light from the optical-disk 10, an objective lens for condensing the laser light applied from the LD, and the like. The pick-up head outputs a tracking error signal (which is hereinafter referred to as a TE signal), a focus error signal (which is hereinafter referred to as a FE signal), and a read signal (which is hereinafter referred to as a RF signal). The TE signal, the FE signal, and the RF signal are, as is known, the signals generated from the outputs from a plurality of the PDs. The TE signal is a signal indicating the amount of displacement between the irradiation position of a laser light and the center of the track formed on the optical disk 10, and the FE signal is a signal indicating the amount of displacement between the focal position of the laser light and the data recording surface of the optical disk 10. The objective lens of the pick-up head is attached to a biaxial actuator, and it is moved in such a direction as to approach to and separate from the optical disk 10 and in the direction of radius of the optical disk 10 by this biaxial actuator. A servo control unit not shown performs known tracking servo control for moving the pick-up head main body or the objective lens in the direction of radius of the optical disk 10 based on the TE signal so that the irradiation position of the laser light is at the center of the track formed on the optical disk 10, and known focus servo control for moving the objective lens of the pick-up head in the direction of approaching to and separating from the optical disk 10 based on the FE signal so that the focal position of the laser light matches the data recording surface of the optical disk 10. Whereas, the recording/reading unit 3 processes the RF signal which is the output from the pick-up head, and acquires the data recorded on the optical disk 10. The data herein acquired is the data encoded by MPEG or the like. The recording/reading unit 3 inputs the data acquired by processing the RF signal to the data processing unit 4.

The data processing unit 4 decodes the data inputted from the recording/reading unit 3, and inputs the decoded data to the input output unit 5. The input output unit 5 inputs the reproduced picture signal or the reproduced audio signal (which are hereinafter collectively referred to as reproduction signals) based on the data inputted from the data processing unit 4 to an external device such as a television receiver connected thereto. Further, the input output unit 5 inputs the picture signal and the audio signal (which are hereinafter collectively referred to as recording signals) inputted from an external device such as a tuner to the data processing unit 4. When a reproduction signal and a recording signal to be inputted to and outputted from the input output unit 5 are analog signals, the reproduction signal is subjected to DA conversion, and outputted to an external device, and the recording signal is subjected to AD conversion, and inputted to the data processing unit 4.

Whereas, the data processing unit 4 encodes the recording signal inputted from the input output unit 5 by MPEG or the like, and inputs the encoded data to the recording/reading unit 3. The recording/reading unit 3 controls the laser light to be applied from the pick-up head onto the optical disk 10 based on the data inputted from the data processing unit 4, and records the data encoded at the data processing unit 4 to the optical disk 10. Further, the recording/reading unit 3 can also apply a laser light of an erasing power to the optical disk 10, thereby to erase the data recorded on the optical disk 10. The power of the laser light to be applied for recording of data (recording power), the power of the laser light to be applied for erasing of data (erasing power), and the power of the laser light to be applied for reading of data (reading power), with respect to the optical disk 10 are, in decreasing order of magnitude, the recording power for the maximum, the erasing power, and the reading power. The recording power is determined by OPC to be carried out prior to recording of data.

Whereas, the operation unit 6 is provided with a receiving unit for receiving a control signal on the main body transmitted in the form of infrared rays or an electromagnetic wave from a remote control device not shown. The control unit 2 controls the apparatus main body according to the input operation at the operation unit 6 (including reception of a control signal from the remote control device).

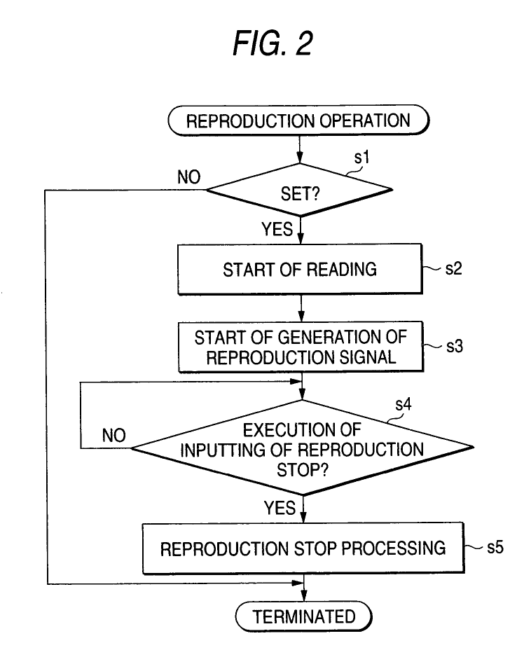

Then, the operation of the optical disk apparatus 1 of this embodiment will be described. FIG. 2 is a flow chart showing the reproduction operation in the optical disk apparatus of this embodiment. The optical disk apparatus 1 executes this processing when an input operation related to the start of reproduction has been performed at the operation unit 6. The optical disk apparatus 1 determines whether the optical disk 10 is set in the apparatus main body, or not (s1). When the optical disk 10 is not set therein, this processing is terminated. On the other hand, when the optical disk 10 is set in the apparatus main body, reading of the data recorded on the optical disk 10 is started (s2). Whereas, each unit of the apparatus main body starts the processing related to the generation of reproduction signals (S3). Specifically, the optical disk apparatus 1 starts tracking servo control and focus servo control. Whereas, the recording/reading unit 3 processes an RF signal which is an output from the pick-up head to acquire the data recorded on the optical disk 10, and starts a processing of sequentially inputting the acquired data to the data processing unit 4. The data processing unit 4 starts decoding of the data inputted from the recording/reading unit 3. Further, the data processing unit 4 sequentially inputs the decoded data to the input output unit 5. The input output unit 5 starts a processing of generating a reproduction signal based on the data inputted from the data processing unit 4, and inputting it to an external device such as a television receiver connected thereto. As a result, picture and audio reproduction based on the reproduction signal is started at the external device connected to the input output unit 5.

When each unit of the apparatus main body starts the processing related to the generation of a reproduction signal at s3, the optical disk apparatus 1 waits for the input operation for reproduction stop to be carried out at the operation unit 6 (s4). When the input operation for reproduction stop is carried out at the operation unit 6, the optical disk apparatus 1 performs a reproduction stop processing for stopping the operation of the recording/reading unit 3, the data processing unit 4, or the input output unit 5 (S5). Then, this processing is terminated.

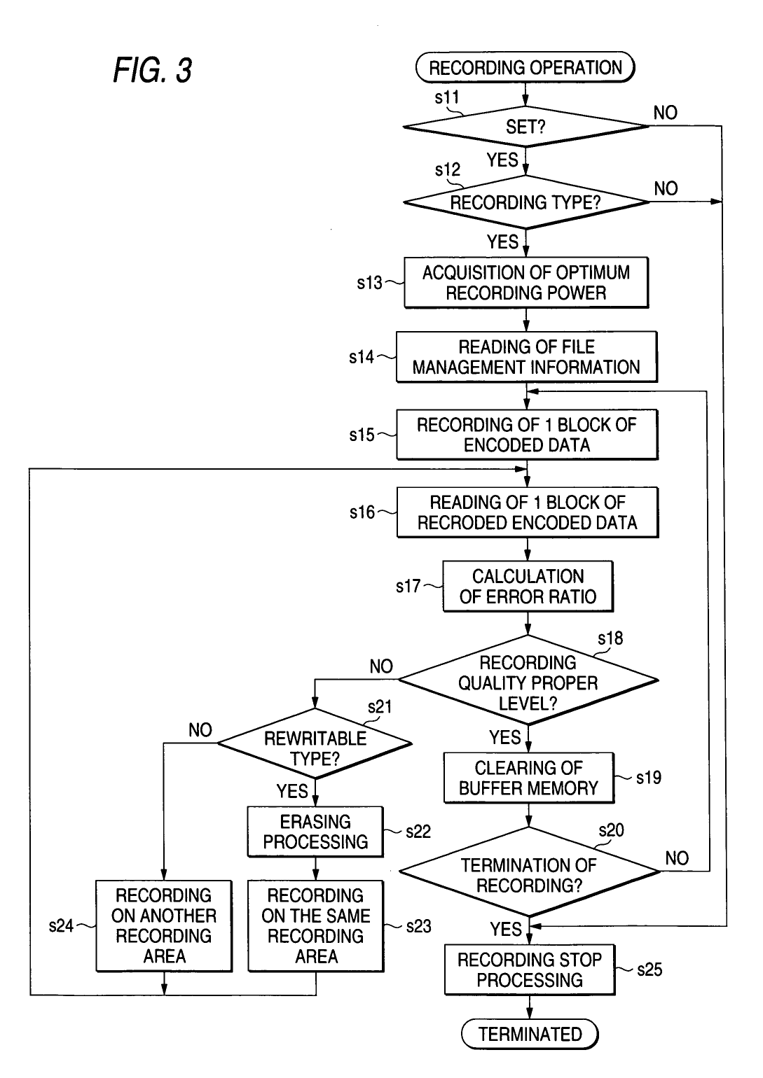

Then, the recording operation of the optical disk apparatus 1 of this embodiment will be described. FIG. 3 is a flowchart showing the recording operation in the optical disk apparatus of this embodiment. The optical disk apparatus 1 executes this processing when an input operation related to the start of recording is performed at the operation unit 6. The optical disk apparatus 1 determines whether the optical disk 10 is set in the apparatus main body, or not (s11). When the optical disk 10 is not set therein, this processing is terminated. On the other hand, when the optical disk 10 is set in the apparatus main body, it is determined whether the optical disk 10 set in the main body is a write-once type or rewritable type optical disk (s12). When the optical disk apparatus 1 determines that the optical disk 10 set in the main body is not a write-once type or rewritable type optical disk, namely, when the optical disk 10 set in the main body is a reproduction-only optical disk, this processing is terminated. When the optical disk apparatus 1 determines that the optical disk 1 set in the main body is a write-once type or rewritable type optical disk at s12, it executes known OPC to acquire the optimum recording power (s13). Further, it reads the file management information recorded on the optical disk 10 (s14). It is possible to determine the available area of the optical disk 10, i.e., the recording area to be hereafter used for recording of data from this file management information.

Whereas, in the optical disk apparatus 1, the input output unit 5 sequentially inputs recording signals inputted from an external device to the data processing unit 4. The data processing unit 4 is provided with a buffer memory (not shown) for temporarily storing the data inputted from the input output unit 5. The data processing unit 4 starts a processing of encoding a predetermined amount of data inputted from the input output unit 5 at one time. Specifically, when a predetermined amount of data related to the recording signal inputted from the input output unit 5 are accumulated, an encoding processing is performed on the prescribed amount of the data. Whereas, also during the period in which the encoding processing is performed, the data inputted from the input output unit 5 is stored in the buffer memory. When this predetermined amount is too small, processings such as recording of data and identification of the recording quality described later are frequently repeated. Whereas, too large amount results in an increase in the frequency of performing a processing related to rerecording of data described later on the recording area in which the recording quality of data has been at a proper level. The predetermined amount is preferably set at several megabytes in size in consideration of these respects.

Herein, the encoded data obtained by encoding a predetermined amount of data inputted from the input output unit 5 is referred to as 1 block of encoded data. The data processing unit 4 inputs 1 block of encoded data to the recording/reading unit 3. The recording/reading unit 3 is provided with a buffer memory (not shown) for temporarily storing 1 block of encoded data. The recording/reading unit 3 stores 1 block of the encoded data inputted from the data processing unit 4 in the buffer memory.

The optical disk apparatus 1 records 1 block of the encoded data stored in the buffer memory by the recording/reading unit 3 on the optical disk 10 (s15). In s15, the recording power of the laser light applied from the pick-up head to the optical disk 10 is controlled based on 1 block of the encoded data to be recorded. At this step, when the optical disk 10 set in the main body is a rewritable type disk, recording of data by the overwrite method is performed. Whereas, as the recording power of the laser light applied from the pick-up head to the optical disk 10, the optimum recording power acquired in s13 is used.

Upon recording 1 block of the encoded data on the optical disk 10, the optical disk apparatus 1 reads 1 block of the encoded data recorded this time from the optical disk 10 (s16). The optical disk apparatus 1 verifies the 1 block of the encoded data read from the optical disk 10 in s16 against 1 block of the encoded data recorded on the optical disk 10 in s15, thereby to calculate the error ratio (s17). This error ratio is the occurrence ratio of inconsistencies in both the data. This error ratio is the parameter related to the recording quality referred to in this invention. The optical disk apparatus 1 determines whether the error ratio calculated in s17 is larger than the predetermined error ratio or not, i.e., whether the recording quality of the data recorded this time is at a proper level or not (s18). When the error ratio calculated in s17 is smaller than the predetermined error ratio, the optical disk apparatus 1 determines that the recording quality of 1 block of the encoded data recorded on the optical disk 10 this time is at a proper level, erases 1 block of the encoded data stored in the buffer memory (1 block of the encoded data recorded on the optical disk 10 this time) (s19), and determines whether recording of data on the optical disk 10 has been completed, or not (s20). In s20, the determination is made by whether the data to be recorded on the optical disk 10 is present in the data processing unit 4, or not. When the optical disk apparatus 1 determines that recording has not been completed in s20, the process returns to s15. At this step, to the recording/reading unit 3, 1 block of encoded data encoded subsequently to 1 block of the encoded data recorded on the optical disk 10 this time is inputted from the data processing unit 4.

Whereas, when the optical disk apparatus 1 determines that the recording quality of the data recorded this time is not at a proper level in s18, it determines whether the optical disk 10 set in the main body is a rewritable type optical disk, or not (s21). When the optical disk apparatus 1 determines that the optical disk 10 is not a rewritable type optical disk (or determines that the optical disk 10 is a write-once type optical disk) in s21, it invalidates the recording area of the optical disk 10 in which 1 block of the encoded data has been recorded this time, and rerecords the same data as 1 block of the encoded data recorded this time in another recording area (s24). Then, the process returns to s16. In s24, recording of data on the optical disk 10 is performed with the optimum recording power acquired in s13.

Whereas, when the optical disk apparatus 1 determines that the optical disk 10 is a rewritable type optical disk in s21, it executes an erasing processing for erasing the recorded data on the recording area of the optical disk 10 in which 1 block of the encoded data has been recorded this time (s22). The erasing processing related to s22 is a processing of irradiating the recording area of the optical disk 10 in which 1 block of the encoded data has been recorded this time with a laser light having an erasing power. When the optical disk apparatus 1 completes the erasing processing related to s22, it rerecords the same data as 1 block of the encoded data recorded this time on the recording area subjected to the erasing processing this time (s23). Then, the process returns to s16. In s23, recording of data on the optical disk 10 is performed with the optimum recording power acquired in s13.

Whereas, when the optical disk apparatus 1 determines that recording has been completed in s20, it executes a processing related to stop of recording such as updating and recording of the file management information on the optical disk 10 (s25). Then, this processing is terminated.

Thus, when the recording quality of the data recorded on the rewritable type optical disk 10 falls short of the proper level, an erasing processing is performed on the area, so that the same data is recorded again. Therefore, in rerecording of data, the number of overwriting operations on the recording area increases by 2. Further, the data has been erased, and hence, it is possible to perform rerecording of data with the optimum recording power. This can prevent the occurrence of the situation in which the recording quality of the rerecorded data is not a proper level. As a result, it is possible to suppress the increase in length of time required for the processing of recording data on a write-once type optical disk with an overwrite method.

Whereas, the amount of data to be recorded on the optical disk 10 and to be determined as to whether the recording quality is proper or not is set to be several megabytes in size. Therefore, processings such as identification of the recording quality are not frequently repeated. Further, the frequency of performing a processing related to rerecording of data on the recording area in which the recording quality of data has been at a proper level is also suppressed. Thus, it is possible to further suppress the increase in length of time required for the processing of recording of data on a write-once type optical disk with an overwrite method.

What is claimed is:

1. An optical disk apparatus comprising:
a recording/reading unit for performing recording and reading of data with respect to an optical disk set in a main body; and
a recording quality determination unit for, when the recording/reading unit has recorded data on the optical disk set in the main body, reading the data recorded this time from the optical disk, and determining whether the recording quality of the data recorded this time is at a proper level or not, wherein
when the recording quality of the data recorded this time has been determined to be not at a proper level by the recording quality determination unit, and when the type of the optical disk on which the data has been recorded this time is a rewritable type, the recording/reading unit executes an erasing processing of erasing the recorded data on the recording area in which the data has been recorded this time in the optical disk, and executes a rerecording processing of recording the same data again on the recording area in which the data has been erased with this erasing processing, and, on the contrary, when the type of the optical disk on which the data has been recorded this time is not a rewritable type, executes a rerecording processing of recording the same data again on another recording area than the recording area in which the data has been recorded this time in the optical disk, and
every time the recording/reading unit records a predetermined amount of data on the rewritable type optical disk, the recording quality determination unit determines whether the recording quality is at a proper level or not with respect to a predetermined amount of the data recorded immediately before.

2. An optical disk apparatus comprising:
a recording/reading unit for performing recording and reading of data with respect to an optical disk set in a main body; and
a recording quality determination unit for, when the recording/reading unit has recorded data on the optical disk set in the main body, reading the data recorded this time from the optical disk, and determining whether the recording quality of the data recorded this time is at a proper level or not, wherein
when the recording quality of the data recorded this time has been determined to be not at a proper level by the recording quality determination unit, and when the type of the optical disk on which the data has been recorded this time is a rewritable type, the recording/reading unit executes an erasing processing of erasing the recorded data on the recording area in which the data has been recorded this time in the optical disk, and executes a rerecording processing of recording the same data again on the recording area in which the data has been erased with this erasing processing.

3. The optical disk apparatus according to claim 2, wherein
every time the recording/reading unit records a predetermined amount of data on the rewritable type optical disk, the recording quality determination unit determines whether the recording quality is at a proper level or not with respect to a predetermined amount of the data recorded immediately before.

4. The optical disk apparatus according to claim 2, wherein
when the recording quality of the data recorded this time has been determined to be not at a proper level by the recording quality determination unit, and when the type of the optical disk on which the data has been recorded this time is not a rewritable type, the recording/reading unit executes a rerecording processing of recording the same data again on another recording area than the recording area in which the data has been recorded this time in the optical disk.
